(19) United States
(12) Patent Application Publication
(10) Pub. No.: US 2023/0208944 A1
(43) Pub. Date: Jun. 29, 2023

(54) PROTOCOL IDENTIFYING APPARATUS, PROTOCOL IDENTIFYING METHOD AND PROGRAM

(71) Applicant: NIPPON TELEGRAPH AND TELEPHONE CORPORATION, Tokyo (JP)

(72) Inventors: Hiroki NAGAYAMA, Tokyo (JP); Takahiro HAMADA, Tokyo (JP); Asami MIYAJIMA, Tokyo (JP); Tomoaki WASHIO, Tokyo (JP)

(21) Appl. No.: 17/999,431

(22) PCT Filed: May 28, 2020
(86) PCT No.: PCT/JP2020/021222

§ 371 Date: Nov. 21, 2022

(51) Int. Cl. H04L 69/18

(52) U.S. Cl. CPC H04L 69/18

(57) ABSTRACT

A protocol identification device retrieves multiple communication data items related to multiple communications from certain source IP addresses to certain destination IP addresses; extracts, based on the multiple communication data items, multiple communications from a single transmission source port to multiple destination ports, as candidates for a first communication based on a first protocol using multiple destination ports, excludes, from among the candidates for the first communication based on the first protocol using the multiple destination ports, a second communication based on a second protocol using a single destination port, and identifies a remaining communication as the first communication based on the first protocol using the multiple destination ports.

### TECHNICAL FIELD

The present disclosure relates to a technique for identifying communication based on a specific application protocol in an industrial network.

### BACKGROUND ART

From the perspective of security assessment, application protocols being used on a network need to be understood to determine whether an unintended application is used maliciously.

Application protocols are typically identified by using information of destination port numbers. Some protocols in an industrial network use a large number of destination port numbers (hereinafter, referred to as a “multiple destination port use protocol”), and as a result, identical protocols might be identified as a large number of different protocols, causing erroneous recognition and poor readability of the protocols.

Examples of the method of identifying application protocols include a method of using destination port numbers and a method of directly analyzing information in a payload.

Examples of the method of using destination port numbers include a method of making and holding a use port number table (correspondence table) for each protocol. When the corresponding table is held for each protocol, a packet using a large number of different destination port numbers can also be identified as a packet based on the same protocol.

Examples of the method for directly analyzing information in a payload include a method of holding dictionary information on a byte string or a character string of the payload and identifying a protocol by referring to the dictionary information when a byte string or character string peculiar to a certain protocol is included in the packet. This method enables protocol identification regardless of port numbers, and using the dictionary information, a packet based on a multiple destination port use protocol can be identified as a packet based on the same protocol (NPL 1).

### CITATION LIST

### Non Patent Literature

NPL 1: S. Dharmapurikar; P. Krishnamurthy; T. Sproull; J. Lockwood; Deep Packet inspection using parallel Bloom filters, Proc. of 11^{th} Symposium on High Performance Interconnects

### SUMMARY OF THE INVENTION

### Technical Problem

Unfortunately a multiple destination port use protocol is a protocol peculiar to a vendor that manufactures industrial network devices, and its specifications are not disclosed in most cases. It is difficult to acquire in advance dictionary information such as destination port numbers and payload structures. Therefore, in the related method using the prior information as described above, a packet based on a multiple destination port use protocol is not easily identified as a packet based on the same protocol.

The present disclosure has been made in view of the above-described issue, and an object of the present disclosure is to provide a technique capable of identifying a packet based on a multiple destination port use protocol as a packet based on the same protocol without using prior information.

### Means for Solving the Problem

According to the disclosed technique, a protocol identification device is provided, the protocol identification device including an acquisition unit that acquires a plurality of pieces of communication data related to a plurality of communications from a certain source IP address to a certain destination IP address; and a protocol identification unit that extracts, using the plurality of pieces of communication data, a plurality of communications from one source port to a plurality of destination ports as a plurality of candidates for communications based on a multiple destination port use protocol, excludes communications based on a single destination port use protocol from the plurality of candidates for the communications based on the multiple destination port use protocol, and identifies remaining communications as the communications based on the multiple destination port use protocol

### Effects of the Invention

The disclosed technique provides a technique capable of identifying a packet based on a multiple destination port use protocol as a packet based on the same protocol without using prior information.

### BRIEF DESCRIPTION OF DRAWINGS

FIG. 1 is an overall configuration diagram of a system according to an embodiment of the present disclosure.

FIG. 2 is a diagram for explaining the definition of a protocol.

FIG. 3 is a diagram for explaining the definition of a protocol.

FIG. 4 is a flowchart for explaining a processing flow of a protocol identification device.

FIG. 5 is a diagram for explaining S104.

FIG. 6 is a diagram for explaining S105.

FIG. 7 is a diagram for explaining S106.

FIG. 8 is a diagram for explaining S106.

FIG. 9 is a diagram for explaining S107.

FIG. 10 is a diagram for explaining S107.

FIG. 11 is a configuration diagram of a protocol identification device according to Example 1.

FIG. 12 is a table indicating an example of visualization without applying a technique according to the present disclosure.

FIG. 13 is a table indicating an example of visualization using a technique according to the present disclosure.

FIG. 14 is a configuration diagram of a protocol identification device according to Example 2.

FIG. 15 is a diagram illustrating an example of the hardware configuration of a device.

### DESCRIPTION OF EMBODIMENTS

Hereinafter, an embodiment of the present disclosure (the present embodiment) will be described with reference to the accompanying drawings. The embodiment to be described below is merely an example, and embodiments to which the present disclosure is applied are not limited to the following embodiment.

In the present embodiment, a “port” is used in the meaning of an entrance (in the case of a destination) or an exit (in the case of a source) of communication data (may be referred to as a “packet”) identified by a port number. Furthermore, srcPort denotes a source port and dstPort denotes a destination port. The srcPort may be used in the meaning of a source port number and the dstPort may be used in the meaning of a destination port number. An “application protocol” may be referred to as a “protocol”.

### Outline of Embodiment

In the present embodiment, a protocol identification device 100 identifies a packet based on a multiple destination port use protocol as a packet based on the same protocol without using prior information.

Many of multiple destination port use protocols identified as the same protocol described above exhibit a behavior that is not found in a typical protocol and fixes a source port to transmit a packet to a large number of destination ports. Thus, the protocol identification device 100 exposes all correspondence relationships between source port numbers and destination port numbers in relation to communication between two hosts, and identifies communications performed from the same source port to a plurality of destination ports, as communications based on a multiple destination port use protocol.

In such case, when a destination port number to be used is duplicated between a multiple destination port use protocol and a typical protocol or among a plurality of multiple destination port use protocols, the protocol identification device 100 also performs exception handling processing capable of correctly distinguishing respective communications.

The protocol identification device 100 in the present embodiment can identify a multiple destination port use protocol that may be erroneously recognized as a plurality of different application protocols in the related art. This makes it possible to more accurately recognize security risks.

### System Configuration

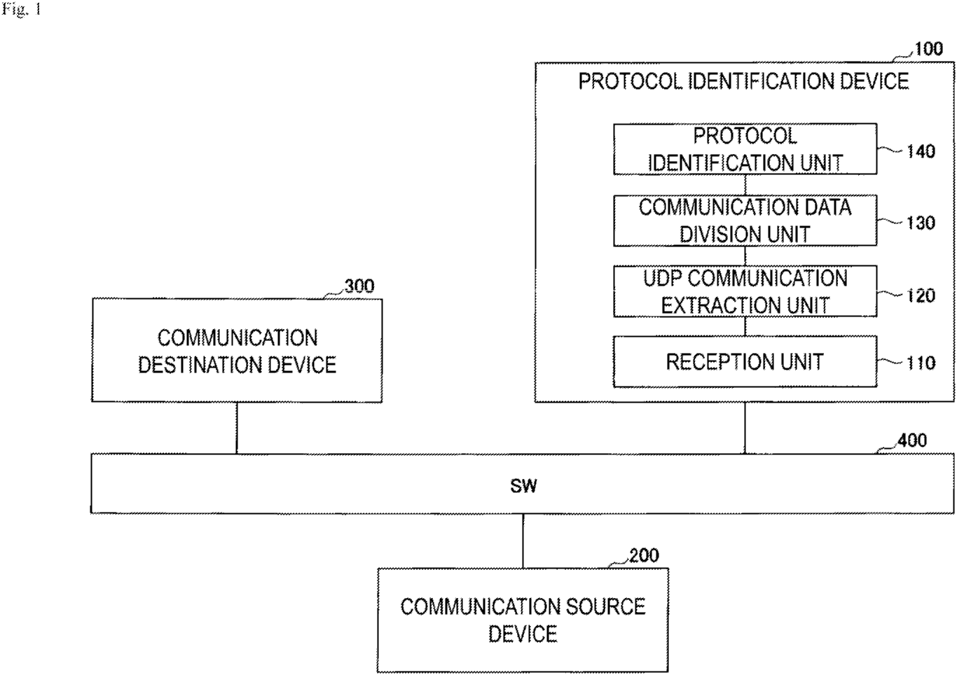

FIG. 1 is a system configuration diagram in the present embodiment. As illustrated in FIG. 1, a system in the present embodiment includes the protocol identification device 100, a communication source device 200, a communication destination device 300, which are connected to a switch (SW) 400 via a network.

The communication source device 200 and the communication destination device 300 are devices that perform IP communication. The communication source device 200 transmits packets, and the communication destination device 300 receives the packets. The communication source device 200 and the communication destination device 300 may each be referred to as a “host.” Although FIG. 1 illustrates one communication source device 200 and one communication destination device 300, a plurality of communication source devices 200 and a plurality of communication destination devices 300 may be provided.

Packets transmitted from the communication source device 200 to the communication destination device 300 are also transmitted to the protocol identification device 100 by the SW 400, so the protocol identification device 100 receives the packets. The protocol identification device 100 performs protocol identification by analyzing the received packets.

As illustrated in FIG. 1, the protocol identification device 100 includes a reception unit 110, a UDP communication extraction unit 120, a communication data division unit 130, and a protocol identification unit 140. A detailed operation of the protocol identification device 100 will be described below.

### Definition and Precondition of Protocol

In describing the operation of the protocol identification device 100 in the present embodiment, the definition and the precondition of a protocol in the present embodiment will be first described.

### Definition of Protocol

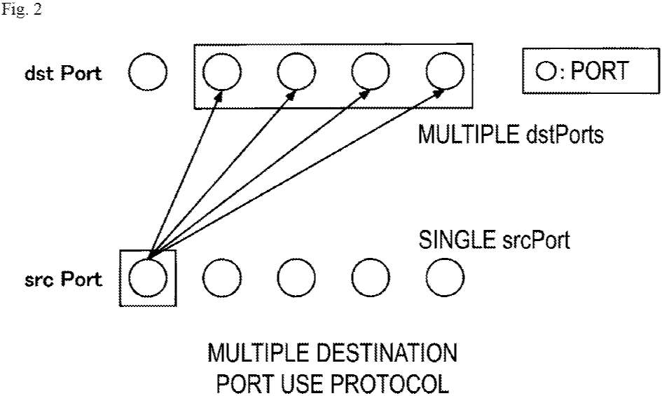

As illustrated in FIG. 2, a “multiple destination port use protocol” is a protocol for performing communication between a certain source IP address (srcIP) and a certain destination IP address (dstIP) and communication addressed to a plurality of destination ports (dstPort) from the same source port (srcPort).

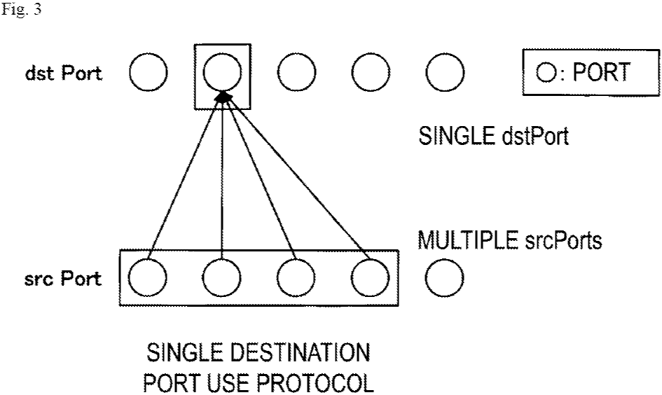

As illustrated in FIG. 3, a “single destination port use protocol” is a protocol for performing communication between a certain source IP address (srcIP) and a certain destination IP address (dstIP) and communication to the same dstPort through srcPort different for each of communication sessions.

A symbol “◯” illustrated in to FIG. 2 and FIG. 3 (the same applies to the following drawings) indicates ports identified by port numbers.

### Precondition of Network in Present Embodiment

In the present embodiment, it is premised that communications based on a multiple destination port use protocol (identification target) and a single destination port use protocol are mixed. Furthermore, it is premised that communication under the multiple destination port use protocol is communication using a user datagram protocol (UDP).

### Operation Example of Protocol Identification Device

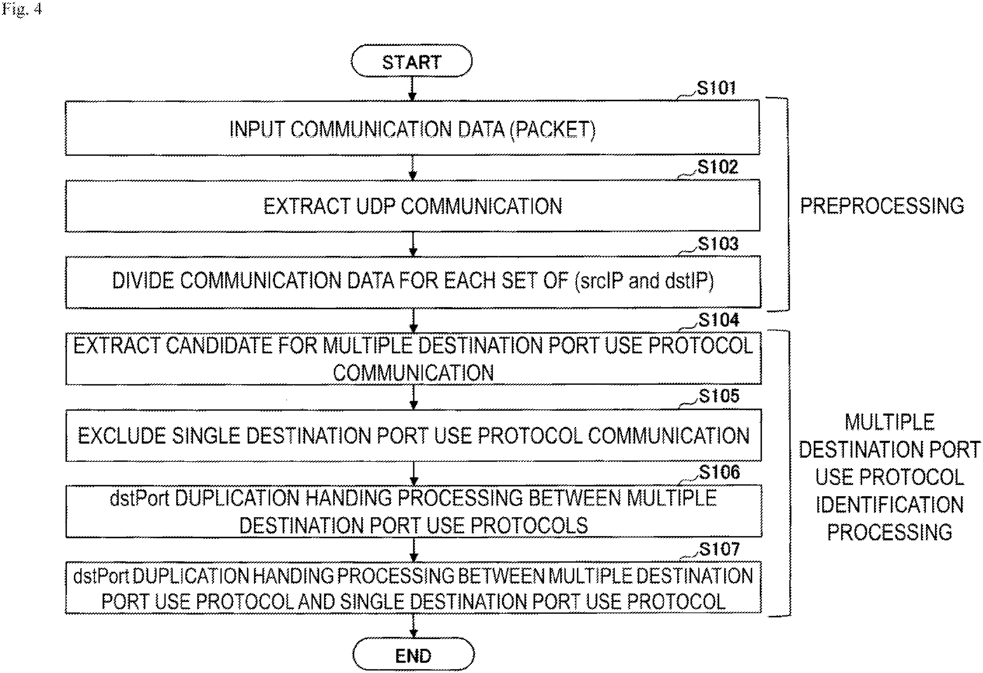

Next, an operation example of the protocol identification device 100 including the configuration illustrated in FIG. 1 will be described according to a procedure illustrated in a flowchart of FIG. 4.

### S101, S102, and S103: Preprocessing

The protocol identification device 100 performs the following S101 to S103 as preprocessing.

In S101, the reception unit 110 receives communication data (may also be referred to as a “packet”). In S101, the reception unit 110 receives, for example, a plurality of pieces of communication data in a predetermined period of time. The pieces of the communication data received by the reception unit 110 are input to the UDP communication extraction unit 120.

In S102, the UDP communication extraction unit 120 extracts communication data of UDP communication from the input communication data. In S103. the communication data division unit 130 divides the communication data for each of sets (srcIP and dstIP) of source and destination IP addresses.

For example, communication data is divided for each of the sets (srcIP and dstIP) of the source and destination IP addresses, such as 10 pieces of communication data with (srcIP1 and dstIP2), 20 pieces of communication data with (srcIP1 and dstIP3), 10 pieces of communication data with (srcIP1 and dstIP3), and 20 pieces of communication data with (srcIP2 and dstIP1).

The pieces of communication data obtained by the division are stored in a storage medium (may also be referred to as a “storage unit”) such as a memory or a hard disk in the protocol identification device 100, and are read by the protocol identification unit 140, and protocol identification processing to be described below is performed.

Since a plurality of pieces of communication data related to communications from a certain source IP address to a certain destination IP address are acquired by the reception unit 110, the UDP communication extraction unit 120, and the communication data division unit 130, the “reception unit + UDP communication extraction unit + communication data division unit” may also be referred to as an “acquisition unit”.

Subsequently, in S104 to S107, the protocol identification unit 140 of the protocol identification device 100 performs processing of identifying a multiple destination port use protocol by analyzing the communication data obtained in S103. Hereinafter, each of the steps S104 to S107 will be described in detail with reference to the drawings.

The steps S104 to S107 are performed for each of sets of source and destination IP addresses. Hereinafter, processing in which a specific set (srcIP and dstIP) is targeted as a set of source and destination IP addresses to be processed.

In the description of S104 to S107, “communication” is identified by a set of (source IP address, source port number, destination IP address, and destination port number). In S104 to S107, since the specific set (srcIP and dstIP) is targeted, “communication” may be identified by a set of (source port number and destination port number).

For example, extracting a communication from source port A (port number=A) to destination port B (port number=B) from a plurality of pieces of communication data corresponds to extracting communication data that matches (srcPort=A and dstPort=B) from the plurality of communication data.

S104: Extraction of Multiple Destination Port Use Protocol Communication Candidate In S104, the protocol identification unit 140 specifies a srcPort, which is a source of a communication addressed to a plurality of dstPorts, from target communication data, as a srcPort of a multiple destination port use protocol communication candidate, and extracts respective communications from the specified srcPort to the plurality of dstPorts as multiple destination port use protocol communication candidates.

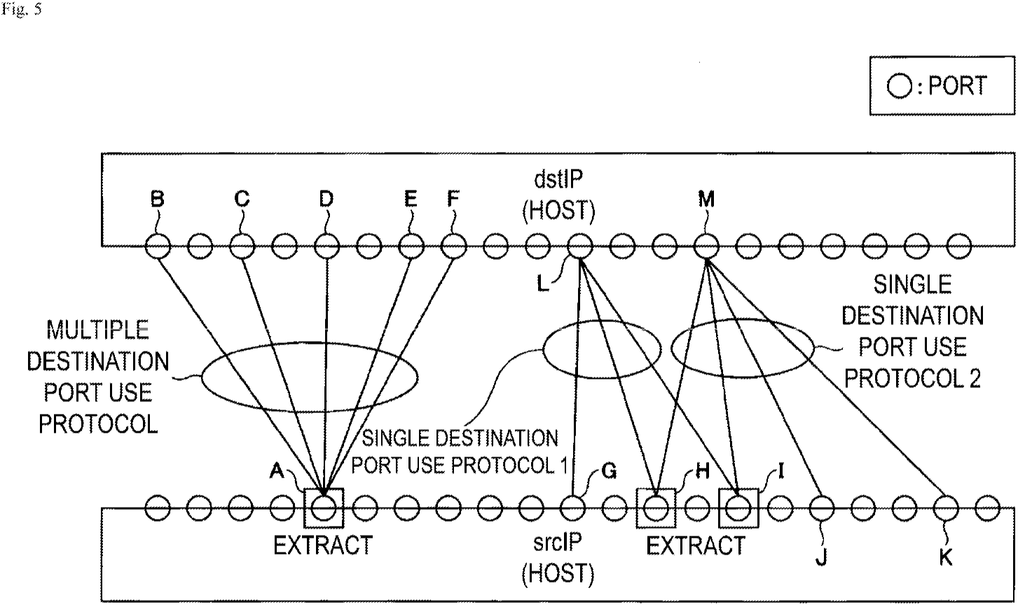

FIG. 5 illustrates an example of extraction. In the example of FIG. 5. since communications addressed to a plurality of dstPorts-B, C, D, E, and F, which use a srcPort-A as a source, are detected on the basis of a plurality of pieces of communication data with a set of (srcIP and dstIP), the protocol identification unit 140 specifies the srcPort-A as a srcPort of a multiple destination port use protocol communication candidate, and extracts respective communications from the specified srcPort-A to the plurality of dstPorts-B, C, D, E, and F as multiple destination port use protocol communication candidates.

Similarly, the protocol identification unit 140 extracts respective communications from a srcPort-H to dstPorts-L and M as multiple destination port use protocol communication candidates, and extracts respective communications from a srcPort-I to the dstPorts-L and M as multiple destination port use protocol communication candidates.

FIG. 5 also illustrates single destination port use protocols 1 and 2 identified by the processing of S105.

S105: Exclusion of Single Destination Port Use Protocol Communication In S 105, the protocol identification unit 140 excludes a single destination port use protocol communication from the multiple destination port use protocol communication candidates extracted in S104. Details are as follows.

The protocol identification unit 140 identifies a destination dstPort of communications using a plurality of srcPorts as sources and each srcPort of sources of the communications addressed to the dstPort from target communication data, determines communications from each srcPort to the destination dstPort as communications based on the single destination port use protocol, and excludes the communications based on the single destination port use protocol from the candidates for the multiple destination port use protocol communication extracted in S104.

The protocol identification unit 140 identifies a communication remaining by excluding the communication based on the single destination port use protocol, as a communication based on the multiple destination port use protocol, and extracts the srcPort of the communication as an identifier of the multiple destination port use protocol communication.

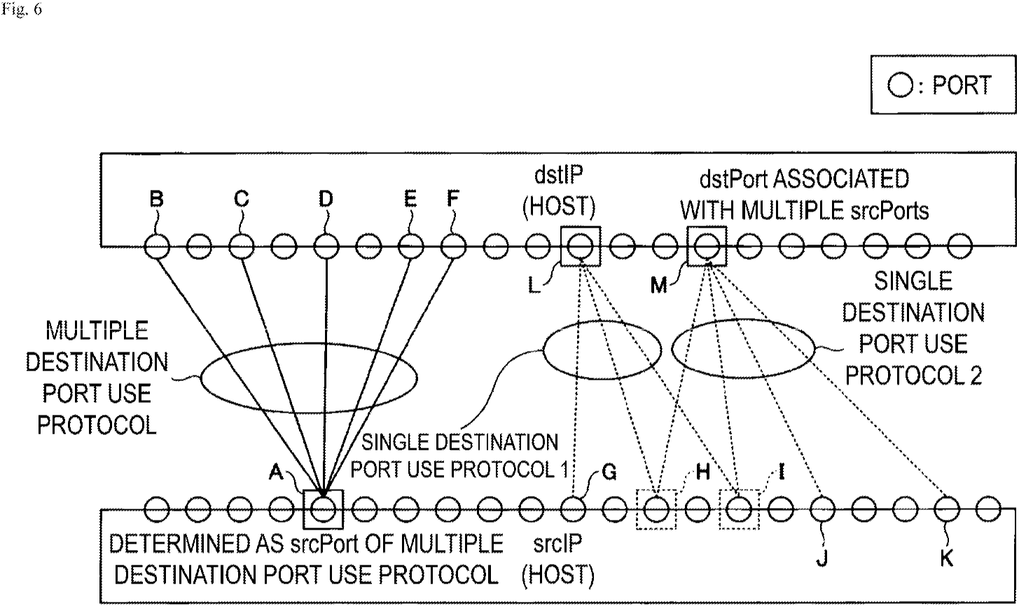

In the specific example of FIG. 6. on the basis of a plurality of pieces of communication data with a set of (srclP and dstIP), the protocol identification unit 140 extracts a communication from a srcPort-G to the dstPort-L, a communication from a srcPort-H to the dstPort-L, and a communication from a srcPort-I to the dstPort-L as communications based on a single destination port use protocol 1. The protocol identification unit 140 extracts a communication from the srcPort-G to a dstPort-J, a communication from the srcPort-H to the dstPort-J, and a communication from the srcPort-I to the dstPort-J as communications based on the single destination port use protocol 1.

Furthermore, the protocol identification unit 140 extracts a communication from the srcPort-H to the dstPort-M, a communication from the srcPort-I to the dstPort-M. a communication from a srcPort-J to the dstPort-M, and a communication from a srcPort-K to the dstPort-M as communications based on a single destination port use protocol 2.

Of the communications based on the single destination port use protocols 1 and 2 described above, the communication from the srcPort-H to the dstPort-L and the communication from the srcPort-H to the dstPort-M are multiple destination port use protocol communications using the srcPort-H as the srcPort, and the communication from the srcPort-I to the dstPort-L and the communication from the srcPort-I to the dstPort-M are multiple destination port use protocol communications using the srcPort-I as the srcPort.

These multiple destination port use protocol communications have been extracted as the candidates for the multiple destination port use protocol communications in S104. In S105, these communications are excluded from communications extracted as the candidates for the multiple destination port use protocol communications in S104.

### S106: dstPort Duplication Handing Processing Between Multiple Destination Port Use Protocols

First, the necessity of S106 will be described. When the used dstPort is duplicated among a plurality of multiple destination port use protocols, communications associated with the duplicated dstPort are determined as communication based on the single destination port use protocol and are excluded in S105.

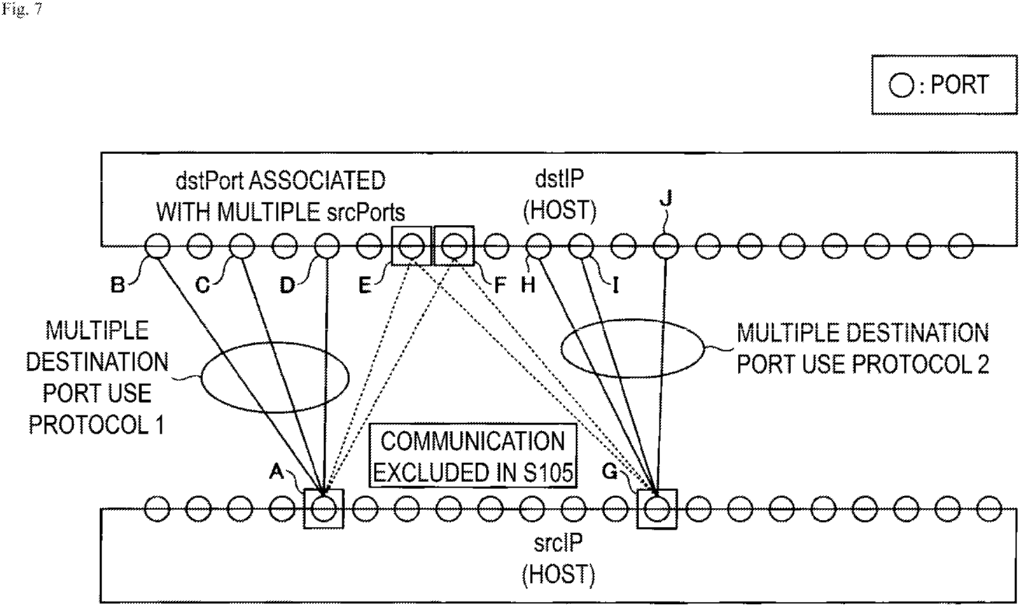

This will be described with reference to FIG. 7. FIG. 7 illustrates an example of extracting two types of multiple destination port use protocol communications, that is, communications based on the multiple destination port use protocol 1 (communications from the srcPort-A to the dscPorts-B, C, D, E, and F) and communications based on the multiple destination port use protocol 2 (communications from the srcPort-G to the dscPorts-E, F, H, I, and J), in S104.

The dstPort-E and F are duplicated between these two types of multiple destination port use protocol communications.

In this case, in S105, single destination port use protocol communications from the srcPorts-A and G to the dstPort-E and single destination port use protocol communications from the srcPorts-A and G to the dstPort-F are excluded. However, all of these communications are not to be excluded because they are a part of communications based on the multiple destination port use protocol. Therefore, it is necessary to exceptionally redetermine these communications as communications based on the multiple destination port use protocol.

Thus, in S106, when the communication excluded in S105 is a communication originated from the scrPort of the multiple destination port use protocol, the protocol identification unit 140 re-identifies the communication as a communication based on the multiple destination port use protocol. That is, the protocol identification unit 140 re-identifies, as a communication based on the multiple destination port use protocol, a communication based on the single destination port use protocol, which has only the scrPort of the multiple destination port use protocol as the scrPort.

In the specific example illustrated in FIG. 7, the communications from the srcPorts-A and G to the dstPort-E and the communications to the srcPorts-A and G to the dstPort-F excluded in S105 both use the srcPorts-A and G as the srcPort, and the srcPorts-A and G have only the srcPort of the multiple destination port use protocol.

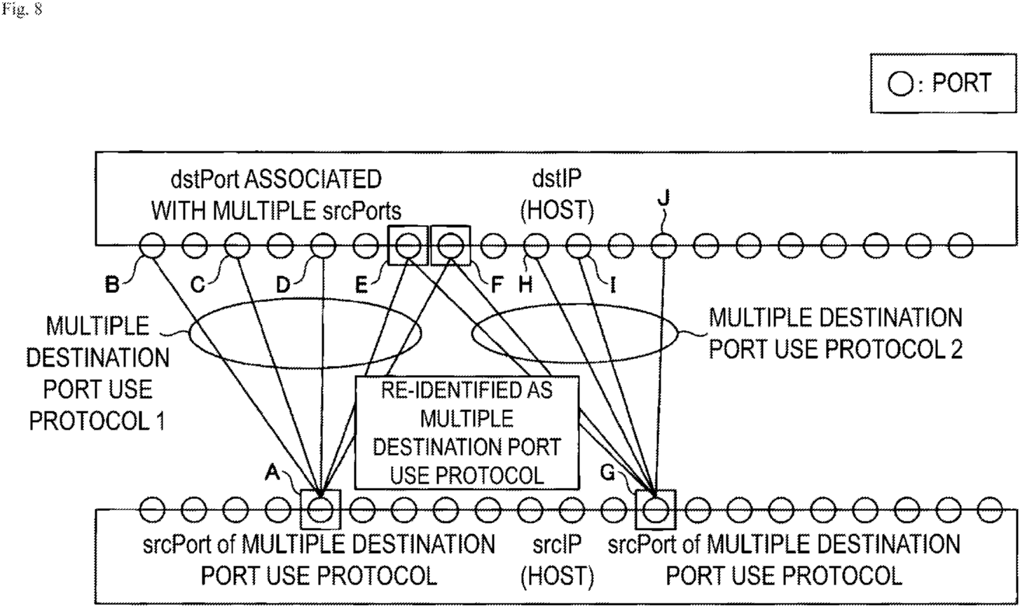

Accordingly, as illustrated in FIG. 8, the protocol identification unit 140 re-identifies communications from the srcPorts-A and G to the dstPort-E and F among the communications from the srcPorts-A and G to the dstPort-E and the communications from the srcPorts-A and G to the dstPort-F as communications based on the multiple destination port use protocol 1, and re-identifies communications from the srcPort-G to the dstPorts-E and F as communications based on the multiple destination port use protocol 2.

### S107: dstPort Duplication Handing Processing Between Multiple Destination Port Use Protocol and Single Destination Port Use Protocol

First, the necessity of S107 will be described. When the used dstPort is duplicated between communications based on the multiple destination port use protocol and communications based on the single destination port use protocol, communications associated with the duplicated dstPort are determined as communications based on the single destination port use protocol and are excluded in S105.

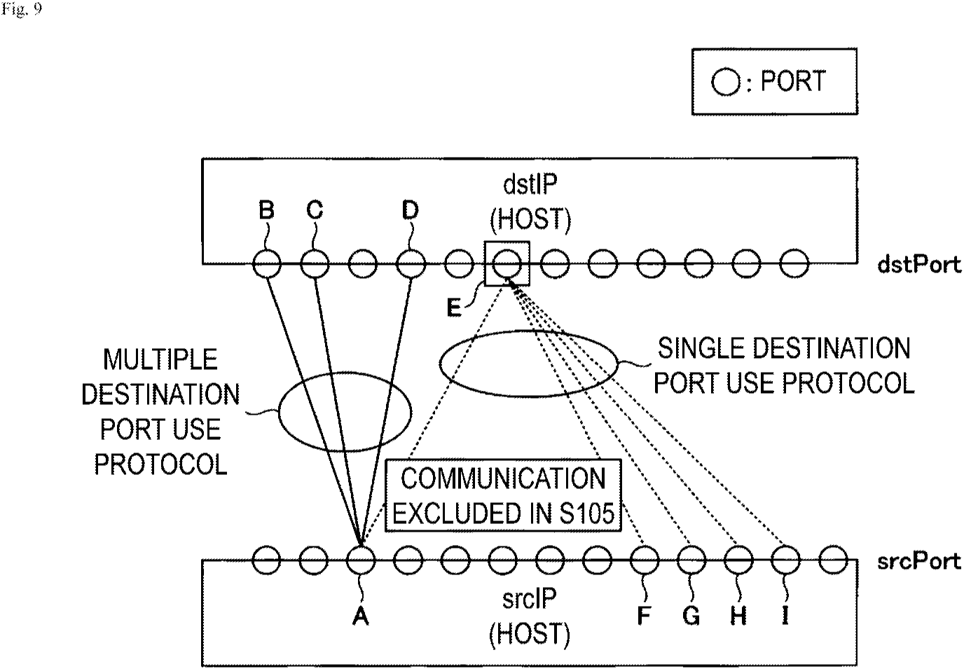

This will be described with reference to FIG. 9. In the example of FIG. 9, in S104, communications based on the multiple destination port use protocol, which are communications from the srcPort-A to the dstPorts-B, C, D, and E, are extracted. In S105, communications based on the single destination port use protocol, which are communications from the srcPorts-A. F, G, H, and I to the dstPort-E, are extracted, and a communication from the srcPort-A to the dstPort-E is excluded from communications based on the multiple destination port use protocol.

However, the communication from the srcPort-A to the dstPort-E is not to be excluded because it is a part of communications based on the multiple destination port use protocol. Therefore, it is necessary to re-determine the communication as a communication based on the multiple destination port use protocol.

Thus, in S107, when the communication excluded in S105 is a communication originated only from the scrPort of the multiple destination port use protocol, the protocol identification unit 140 re-identifies the communication as a communication based on the multiple destination port use protocol.

That is, among the communications based on the single destination port use protocol excluded from the candidates in S105, the protocol identification unit 140 re-identifies a communication based on the single destination port use protocol from a source port of the multiple destination port use protocol related to the candidate as a communication based on the multiple destination port use protocol, the single destination port use protocol having a destination port of the multiple destination port use protocol related to the candidate as a destination port.

In the specific example illustrated in FIG. 9, the communication from the srcPort-A to the dstPort-E excluded in S105 is a communication based on the single destination port use protocol from the srcPort-A of the multiple destination port use protocol, the single destination port use protocol having the dstPort-E of the multiple destination port use protocol as a destination port.

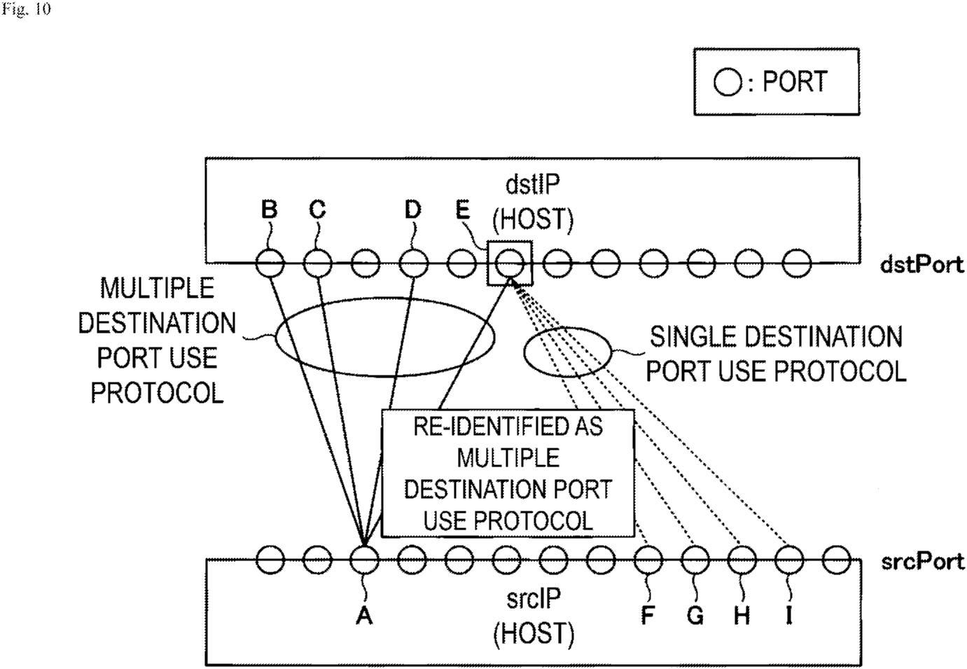

Thus, as illustrated in FIG. 10, a communication from the rcPort-A to the dstPort-E is re-identified as a communication based on the multiple destination port use protocol.

Hereinafter, Examples 1 and 2 will be described as examples using the protocol identification technique described above. Examples 1 and 2 may be implemented in combination.

### Example 1

In Example 1, in an industrial control system network, the protocol identification device 100 specifies an application used by each host.

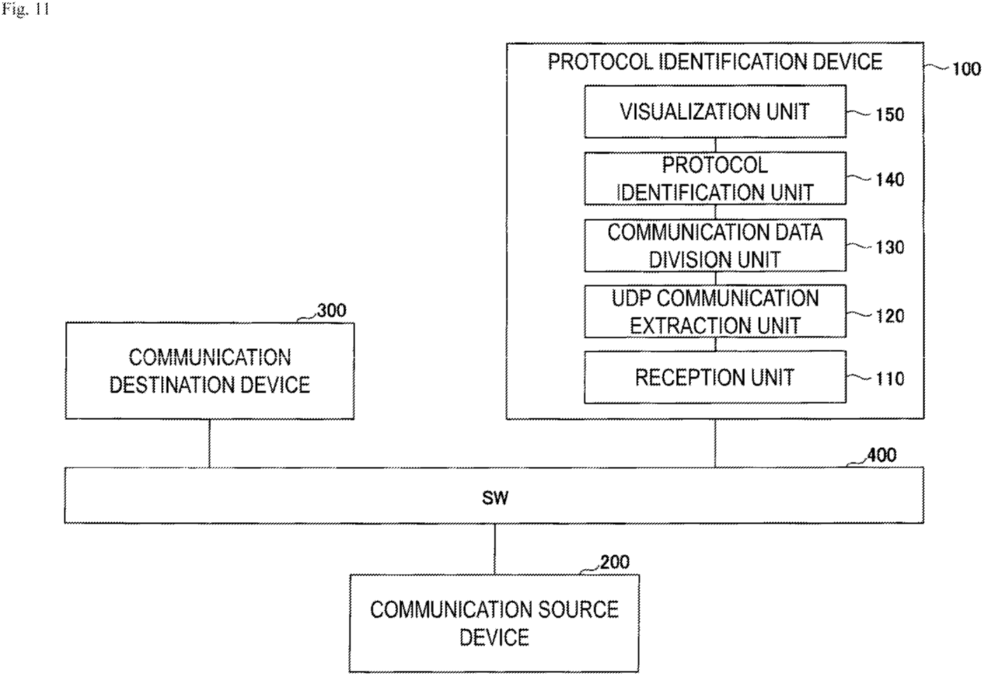

FIG. 11 illustrates a configuration example of a system including the protocol identification device 100 in Example 1. As illustrated in FIG. 11, the protocol identification device 100 of Example 1 includes the reception unit 110, the UDP communication extraction unit 120, the communication data division unit 130, the protocol identification unit 140, and a visualization unit 150. The reception unit 110, the UDP communication extraction unit 120, the communication data division unit 130, and the protocol identification unit 140 are as described above.

The visualization unit 150 displays an application protocol name identified by the protocol identification unit 140. When the protocol identification unit 140 is not able to identify an application protocol, the visualization unit 150 displays a set of (a port number and an L4 protocol name) as an application name

Example 1 has a network environment condition that there is an application protocol that communicates with ports with more than 10,000 destination port numbers by using source port number 13000, the application protocol having a non-disclosed specification.

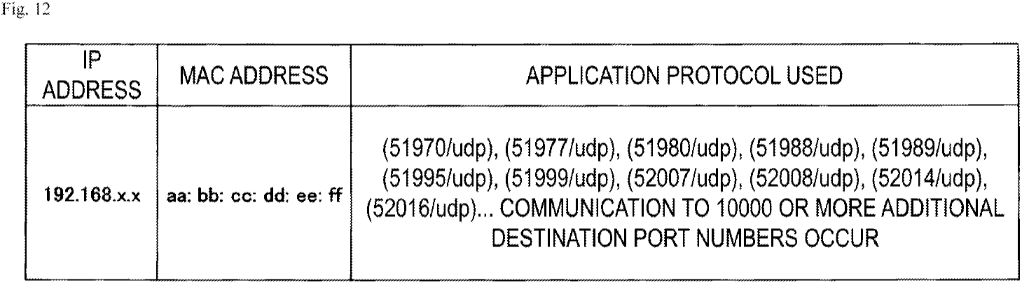

FIG. 12 illustrates a display example in which an application protocol is identified and visualized on the basis of a destination port number without applying the technique according to the present disclosure. FIG. 12 illustrates an IP address and a MAC address of a source and an identified application protocol.

As illustrated in FIG. 12. when the technique according to the present disclosure is not applied, it appears as though an application protocol is operating for each of 10,000 or more port numbers. Therefore, it is not possible to accurately ascertain the number of applications that originally exist, and the readability of a visualization result is greatly reduced.

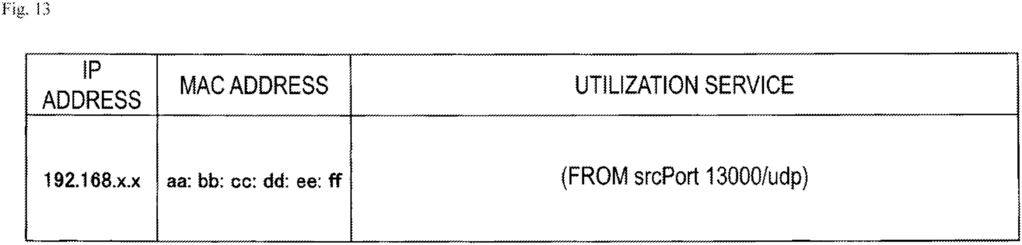

FIG. 13 illustrates a display example in which visualization is performed by the protocol identification device 100 of Example 1. FIG. 13 illustrates an IP address and a MAC address of a source and an identified service.

As illustrated in FIG. 13, a communication using a plurality of destination ports from the same source port (port number 13000) is identified and displayed as one application (service) by using a source port number as an identification key. This makes it possible to accurately ascertain the number of applications, and improves readability.

### Example 2

In Example 2, the protocol identification device 100 automatically generates a white list entry in an industrial control system network.

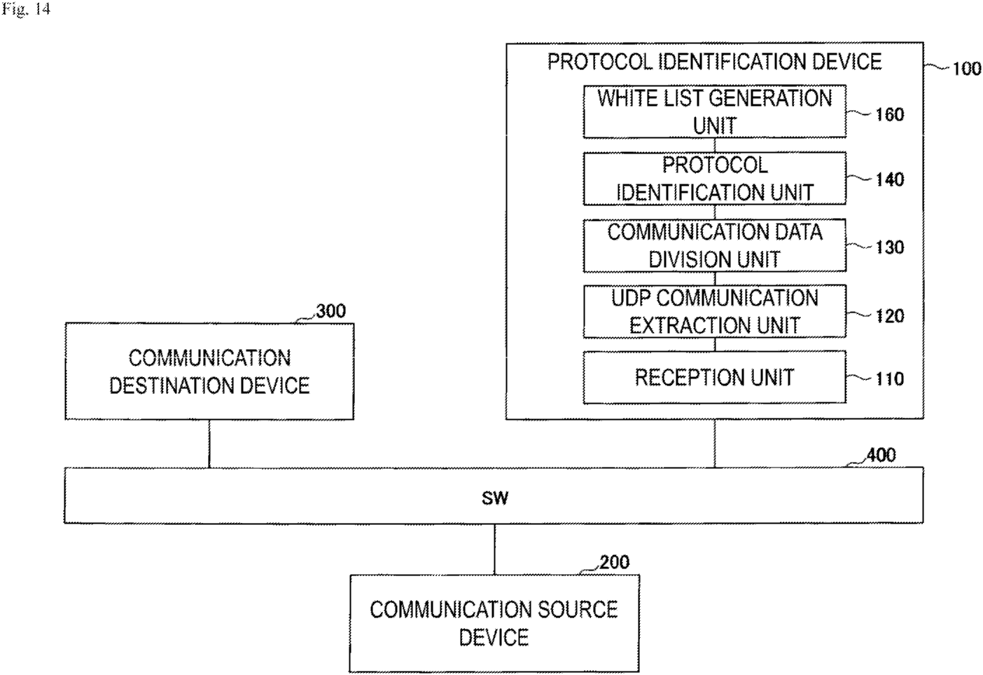

FIG. 14 illustrates an example of the configuration of a system including the protocol identification device 100 in Example 2. As illustrated in FIG. 14, the protocol identification device 100 of Example 2 includes the reception unit 110, the UDP communication extraction unit 120, the communication data division unit 130, the protocol identification unit 140, and a white list generation unit 160. The reception unit 110, the UDP communication extraction unit 120, the communication data division unit 130, and the protocol identification unit 140 are as described above. The white list generation unit 160 generates an entry of a white list by a method to be described below.

Example 2 has a network environment condition that there is an application protocol that communicates with ports with more than 10,000 destination port numbers by using source port number 13000, the application protocol having a non-disclosed specification.

In Example 2. first, the protocol identification unit 140 applies the technique according to the present disclosure to acquired communication data (may also be referred to as a “packet”), and extracts the srcPort of the multiple destination port use protocol. For convenience of description, this extracted srcPort is referred to as the “srcPort-A”. When there are a plurality of extracted srcPorts, the following processing is performed for each srcPort.

The white list generation unit 160 performs (1) processing related to the multiple destination port use protocol communication and (2) processing related to the single destination port use protocol communication. Hereinafter, the processing (1) and the processing (2) will be described.

(1) Processing related to Multiple Destination Port Use Protocol Communication The white list generation unit 160 extracts a destination port number (dstPort) of each piece of communication data in which the srcPort-A of the multiple destination port use protocol identified by the srcPort-A is used as a source port number, and calculates a minimum value and a maximum value of the extracted dstPort.

Subsequently, the white list generation unit 160 sets entry information (srcIP, dstIP. srcPort, dstPort, and udp/tcp) of the communication data with the srcPort-A of the multiple destination port use protocol as a source port number. The range of only the dstPort is designated, and the range is set from the minimum value to the maximum value extracted in advance. When the range designation is not possible, the dstPort is set as a wild card.

By the above processing, a white list related to the multiple destination port use protocol communication is generated.

(2) Processing related to Single Destination Port Use Protocol Communication The white list generation unit 160 sets entry information (srcIP, dstIP, dstPort, and udp/tcp) in communication data with respect to communication data in which the srcPort-A of the multiple destination port use protocol identified by the srcPort-A is not used as a source port number, and the srcPort is set as a wild card.

By the above processing, a white list related to the single destination port use protocol communication is generated.

### Expected Effects of Example 2

Example 2 enables the reduction of device resources and operation management cost. That is, according to Example 2, the number of white list entries is significantly reduced by compressing the dstPorts of 10,000 or more available multiple destination port use protocols into one entry with a designated range without registering the dstPorts as a separate entry, and it is possible to reduce device resources of an intrusion detection system (IDS) and the like and white list operation management cost of an IDS operator.

### Hardware Configuration Example

The protocol identification device 100 in the present embodiment described with reference to FIG. 1, FIG. 11, and FIG. 14 can be implemented by, for example, causing a computer to execute a program describing processing contents described in the present embodiment.

The above program can be stored or distributed with the program recorded on a computer readable recording medium (such as a portable memory). The above program can also be provided through a network such as the Internet or e-mail.

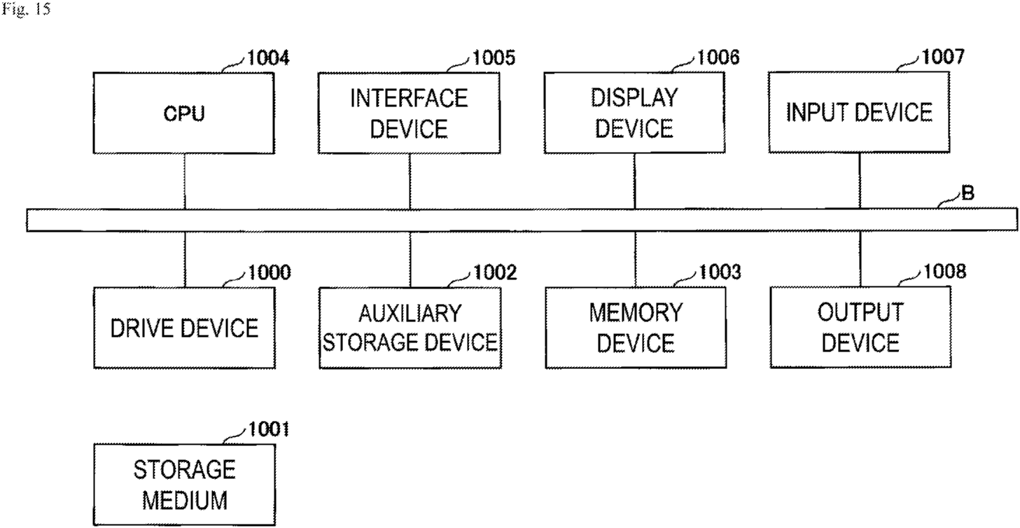

FIG. 15 is a diagram illustrating an example of the hardware configuration of the above computer. In FIG. 15, the computer includes a drive device 1000, an auxiliary storage device 1002, a memory device 1003. a CPU 1004, an interface device 1005, a display device 1006, an input device 1007, an output device 1008, and the like, which are connected to one another through a bus BS.

A program for implementing processing in the computer is provided by a recording medium 1001 such as a CD-ROM or a memory card. When the recording medium 1001 having a program stored therein is set in the drive device 1000, the program is installed from the recording medium 1001 through the drive device 1000 to the auxiliary storage device 1002. However, the program does not have to be installed from the recording medium 1001, and may be downloaded from another computer through a network. The auxiliary storage device 1002 stores the installed program, and stores necessary files, data, and the like.

In response to an activation instruction of the program, the memory device 1003 reads out the program from the auxiliary storage device 1002 and stores the program. The CPU 1004 implements functions related to the protocol identification device 100 according to the program stored in the memory device 1003. The interface device 1005 is used as an interface for connection to a network. The display device 1006 displays a graphical user interface (GUI) or the like based on the program. The input device 1007 includes a keyboard, a mouse, a button, a touch panel, or the like, and is used for inputting various operation instructions. The output device 1008 outputs the calculation result.

### Effects of Embodiment

In accordance with the technique according to the present embodiment, it is possible to identify a multiple destination port use protocol that may be erroneously recognized as a plurality of different application protocols in the related art, and to more accurately recognize security risks.

### Conclusion of Embodiment

The present specification describes a protocol identification device, a protocol identification method, and a program described in at least each of the following paragraphs.

### Paragraph 1

A protocol identification device including:
an acquisition unit that acquires a plurality of pieces of communication data related to a plurality of communications from a certain source IP address to a certain destination IP address; and
a protocol identification unit that extracts, using the plurality of pieces of communication data, a plurality of communications from one source port to a plurality of destination ports as a plurality of candidates for communications based on a multiple destination port use protocol, excludes communications based on a single destination port use protocol from the plurality of candidates for the communications based on the multiple destination port use protocol, and identifies remaining communications as the communications based on the multiple destination port use protocol.

### Paragraph 2

The protocol identification device according to paragraph 1, in which the protocol identification unit re-identifies the communications based on the single destination port use protocol, in the communications based on the single destination port use protocol excluded from the plurality of candidates, as the communications based on the multiple destination port use protocol, the communications based on the single destination port use protocol having only source ports of the multiple destination port use protocol as a plurality of source ports.

### Paragraph 3

The protocol identification device according to paragraph 1 or 2, in which, in the communications of the signal destination port user protocol excluded from the plurality of candidates, the protocol identification unit re-identifies, as the communications based on the multiple destination port use protocol, a plurality of communications from the plurality of source ports of the multiple destination port use protocol related to the plurality of candidates in the single destination port use protocol using a destination port of the multiple destination port use protocol related to the plurality of candidates.

### Paragraph 4

The protocol identification device according to any one of paragraphs 1 to 3, in which the protocol identification unit extracts the source port of the communication identified as the communication based on the multiple destination port use protocol as an identifier of the multiple destination port use protocol, and the protocol identification device includes a visualization unit that displays the identifier.

### Paragraph 5

The protocol identification device according to any one of paragraphs 1 to 4, further including: a white list generation unit that generates a white list having a range specification by a minimum value and a maximum value of a source port number and a destination port number of the communication based on the multiple destination port use protocol extracted by the protocol identification unit.

### Paragraph 6

A protocol identification method performed by a protocol identification device, the method including acquiring a plurality of pieces of communication data related to a plurality of communications from a certain source IP address to a certain destination IP address; and extracting, using the plurality of pieces of communication data, a plurality of communications from one source port to a plurality of destination ports as a plurality of candidates for communications based on a multiple destination port use protocol, exclude communications based on a single destination port use protocol from the plurality of candidates for the communications based on the multiple destination port use protocol, and identify remaining communications as the communications based on the multiple destination port use protocol.

### Paragraph 7

A program causing a computer to operate as each unit constituting the protocol identification device according to any one of paragraphs 1 to 5.

Although the present embodiment has been described above, the present disclosure is not limited to such a specific embodiment, and can be modified and changed variously without departing from the scope of the present disclosure described in the appended claims.

### REFERENCE SIGNS LIST

100 Protocol identification device
110 Reception unit
120 UDP communication extraction unit
130 Communication data division unit
140 Protocol identification unit
150 Visualization unit
160 White list generation unit
200 Communication source device
300 Communication destination device
400 SW
1000 Drive device
1001 Recording medium
1002 Auxiliary storage device
1003 Memory device
1004 CPU
1005 Interface device
1006 Display device
1007 Input device
1008 Output device

1. A protocol identification device comprising:
a processor, and
a memory that includes instructions, which when executed, cause the processor to execute the following steps:
retrieving multiple communication data items related to multiple communications from certain source IP addresses to certain destination IP addresses; and
extracting, based on the multiple communication data items, multiple communications from a single transmission source port to multiple destination ports, as candidates for a first communications based on a first protocol using multiple destination ports;
excluding, from among the candidates for the first communication based on the first protocol using the multiple destination ports, a second communication based on a second protocol using a single destination port, and
identifying a remaining communication as the first communications based on the first protocol using the multiple destination ports.

2. The protocol identification device according to claim 1, wherein the identifying re-identifies, from among the one or more second communications based on the second protocol using the single destination port, the one or more second communications being excluded from the candidates, a communication having a transmission source port that is used in the first protocol as a transmission source port, as a communication based on the first protocol.

3. The protocol identification device according to claim 1,
wherein, from among the one or more second comniunications based on the second protocol using the single destination port, the one or more second communications being excluded from the candidates, the identifying re-identifies a communication from a transmission source port used indication the first protocol using the multiple destination ports, the communication having a destination port used in the first protocol using the multiple destination ports related to the candidates, as the first communication based on the first protocol using the multiple destination ports.

4. The protocol identification device according to claim 1 ,
wherein the identifying extracts a transmission source port of a communication that is identified as the first communication based on the first protocol using the multiple destination ports, as an identifier of the first protocol using the multiple destination ports, and
wherein the protocol identification device further includes a display to display the identifier.

5. The protocol identification device according to claim 1, wherein the steps executed by the processor further includes
generating a white list having a transmission source port number of the first communication, the first communication being extracted by the identifying, the first communication based on the first protocol using the multiple destination ports, and a specified range defined by a minimum value and a maximum value of the destination port number of the first communication based on the first protocol using the multiple destination ports.

6. A protocol identification method performed by a protocol identification device, the method comprising:
retrieving multiple communication data items related to multiple communications from certain source IP addresses to certain destination IP addresses:
extracting, based on the multiple communication data items, multiple communications from a single transmission source port to multiple destination ports, as candidates for a first communication based on a first protocol using multiple destination ports;
excluding, from among the candidates for the first communication based on the first protocol using the multiple destination ports, a second communication based on a second protocol using a single destination port, and
identifying a remaining communication as the first communication based on the first protocol using the multiple destination ports.

7. A non-transitory computer readable storage medium storing a program for causing the protocol identification device to execute the protocol identification method according to claim 6.
